(19) United States
(12) Patent Application Publication
(10) Pub. No.: US 2015/0212261 A1
(43) Pub. Date: Jul. 30, 2015

(54) LIGHTING APPARATUS, DISPLAY APPARATUS, AND TELEVISION RECEIVER

(71) Applicant: Sharp Kabushiki Kaisha, Osaka (JP)

(72) Inventor: Yusuke Masuda, Osaka (JP)

(73) Assignee: Sharp Kabushiki Kaisha, Osaka (JP)

(21) Appl. No.: 14/419,827

(22) PCT Filed: Aug. 1, 2013
(86) PCT No.: PCT/JP2013/070871

§ 371 Date: Feb. 5, 2015

(30) Foreign Application Priority Data
Aug. 8, 2012 (JP) 2012-175864

(51) Int. Cl. F21V 8/00; H04N 5/645; G02F 1/1333

(52) U.S. Cl. CPC G02B 6/0088; G02B 6/005; G02B 6/0085; G02F 1/133308; H04N 5/645; G02F 2001/13332; G02F 2001/133314

(57) ABSTRACT

A backlight apparatus includes LEDs; a light guide plate; an optical member; a chassis formed by bending a metal plate material, the chassis including a bottom plate (plate portion) that extends along the light guide plate, a rising portion (first extending portion) that rises from the bottom plate on an opposite side to the light guide plate and forms a first corner portion with the bottom plate, and a height-difference portion that forms a second corner portion with the rising portion and provides a height-difference portion with respect to the bottom plate; and a heat dissipating member that dissipates heat of the LEDs, the heat dissipating member including a light source attachment portion to which the LEDs are attached and a chassis contacting portion that is contiguous with the light source attachment portion and is in contact with the height-difference portion from the opposite side to the light guide plate.

### TECHNICAL FIELD

The present invention relates to an illumination device, a display device, and a television receiver.

### BACKGROUND ART

In recent years, as the display element in image display devices such as television receivers has gone from being conventional cathode-ray tubes a thin-screen display panel such as a liquid crystal panel, plasma display panel or the like, it has become possible to make image display apparatuses having a thinner profile. In liquid crystal display devices, the employed liquid crystal panel does not generate light itself, but requires a separate backlight device as an illumination device. Backlight devices can be broadly classified as being either of a direct or edge-lit type. To realize even thinner liquid crystal display devices, it is preferable to use an edge-lit backlight device, a well-known example of which is described in the below-mentioned Patent Document 1.

Patent Document 1 discloses a backlight device including a light guide plate, an optical sheet arranged on a top surface of the light guide plate, a light source arranged one side of the light guide plate, and a lower housing that houses the light guide plate and the light source. Here, the lower housing includes a light source portion fixing frame in which the light source is fixed, and a chassis (housing portion) arranged under the light guide plate and coupled to the light source portion fixing frame. Also, a portion (plate) of the light source fixing frame is arranged outward of a bottom surface of the chassis such that heat generated by the light source is discharged directly to the outer side of the lower housing, thereby enabling a increase in heat dissipation efficiency.

### RELATED ART DOCUMENT

### Patent Document

Patent Document 1: Japanese Patent Application Laid-Open Publication No. 2011-86627

### Problems to be Solved by the Invention

However, with heat dissipation members such as the light source fixing frame, heat is not just dissipated into the air outside the backlight device, but also transmitted inside the backlight device via the chassis. Here, for the chassis of the backlight device, it is preferable, from the point of view of mechanical strength (stiffness), cost, and the like, to use a member made of a metal such as iron. In such cases, since the thermal conductivity of the chassis is higher than air, the proportion of heat transmitted to the inside of the of backlight device from the heat dissipating member increases relative to the heat dissipated to the outside of the backlight device from the heat dissipating member.

An optical sheet is arranged inside the backlight device. In the optical sheet, the portion overlapping the heat dissipating member undergoes thermal expansion due to the heat from the heat dissipating member, putting it at risk of deformation by wrinkling, bending or the like.

### SUMMARY OF THE INVENTION

The present invention was completed based on the above-described circumstances, and provides an illumination device in which deformation of an optical sheet by wrinkling, bending or the like is suppressed by suppressing transmission of heat from a heat dissipating member to inside an illumination device.

### Means for Solving the Problem

The illumination device of the present invention includes: a light source; a light guide plate that faces the light source and that has a light incident face on which light from the light source is incident and a light exiting surface from which light exits; an optical sheet arranged on a side of the light guide plate adjacent to the light exiting surface thereof; a chassis formed by bending a metal plate and arranged on a side of the light guide plate opposite to the light exiting surface thereof, the chassis being constituted of a bottom plate that extends along the light guide plate, a rising portion that rises from the bottom plate to a side opposite to the light guide plate and that forms a first corner portion with the bottom plate, and a height-difference portion that forms a second corner portion with the rising portion and provides a difference in height with respect to the bottom plate; and a heat dissipating member that dissipates heat from the light source, the heat dissipating member being constituted of a light source attachment portion to which the light source is attached and a chassis contacting portion that is contiguous with the light source attachment portion and in contact with the height-difference portion from a side opposite to the light guide plate.

In the illumination device, the first corner portion and the second corner portion formed by bending a metal plated are formed in the chassis between the bottom plate and the height-difference portion. In this process, since warping and cracking occur when bending a metal, corner portions formed by bending the metal material have a higher thermal resistance than flat portions. Hence, in above-described illumination device, the conduction of heat from the height-difference portion to the bottom plate is more difficult than when the height-difference portion and the bottom plate form a continuous flat plane.

Also, since the chassis contacting portion of the heat dissipating member is in contact with the height-difference portion from the opposite side of the chassis to the light guide plate, heat is dissipated via the chassis contacting portion. In comparison to the case in which the height-difference portion and the bottom plate form a continuous flat surface, the amount of heat dissipated from the chassis contacting portion on the chassis side is reduced, and the amount of heat dissipated from the opposite side to the chassis 30 is increased. As a result, it becomes more difficult for the heat from the heat dissipating member to reach the optical sheet, which is disposed on the chassis side with respect to the chassis contacting portion. Hence, the occurrence of wrinkling in the optical member due to thermal expansion of the section of the optical member overlapping the chassis contacting portion can be suppressed.

### Effects of the Invention

According to the present invention, it is possible to provide an illumination device or the like in which deformation of an optical sheet by wrinkling, bending, or the like is suppressed.

### BRIEF DESCRIPTION OF THE DRAWINGS

FIG. 1 is an exploded perspective view schematically showing a configuration of a television receiver TV and a liquid crystal display unit LDU according to Embodiment 1.

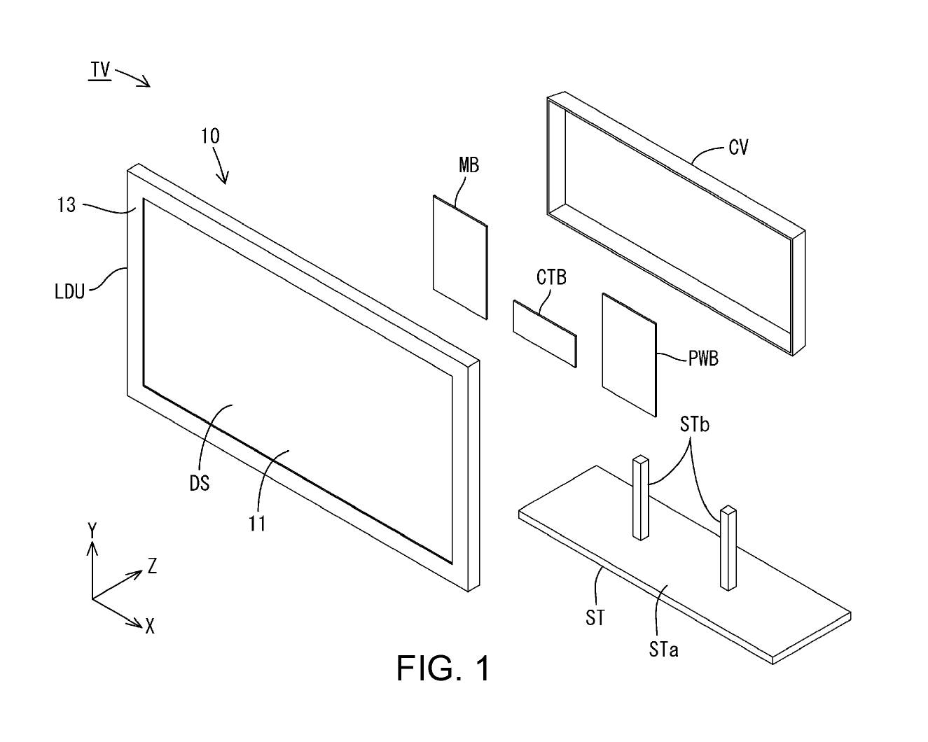

FIG. 2 is a rear view of the television receiver TV and a liquid crystal display device 10.

FIG. 3 is an exploded perspective view schematically showing a configuration of a liquid crystal display unit LDU forming a portion of the liquid crystal display device 10.

FIG. 4 is a cross-sectional view showing a cross-sectional configuration along a short-side direction of the liquid crystal display device 10.

FIG. 5 is a cross-sectional view of important parts of a backlight device 12, showing an enlargement of a region in proximity to one of the LED units LU in FIG. 4.

FIG. 6 is a view of a cross-sectional configuration along a short-side direction of a liquid crystal display device 110 according to Embodiment 2. Specifically, FIG. 6 is a cross-sectional view of important parts of the liquid crystal display device 110, showing an enlarged region in proximity to one of the LED units LU.

FIG. 7 is a view of a cross-sectional configuration along a short-side direction of a liquid crystal display device 210 according to Embodiment 3. Specifically, FIG. 7 is a cross-sectional view of important parts of the liquid crystal display device 210, showing an enlarged region in proximity to one of the LED units LU.

### DETAILED DESCRIPTION OF EMBODIMENTS

### Embodiment 1

Embodiment 1 is described below with reference to the drawings. The present embodiment is exemplified by a liquid crystal display device (example of a display device) 10. Note that an X-axis, Y-axis and Z-axis are indicated in the drawings, and the depicted portions are depicted with common axis orientation in each drawing. Of these axes, the Y-axis direction corresponds to a vertical direction, and the X-axis direction corresponds to a horizontal direction. Where not otherwise specified, descriptions of up and down are based on the vertical direction.

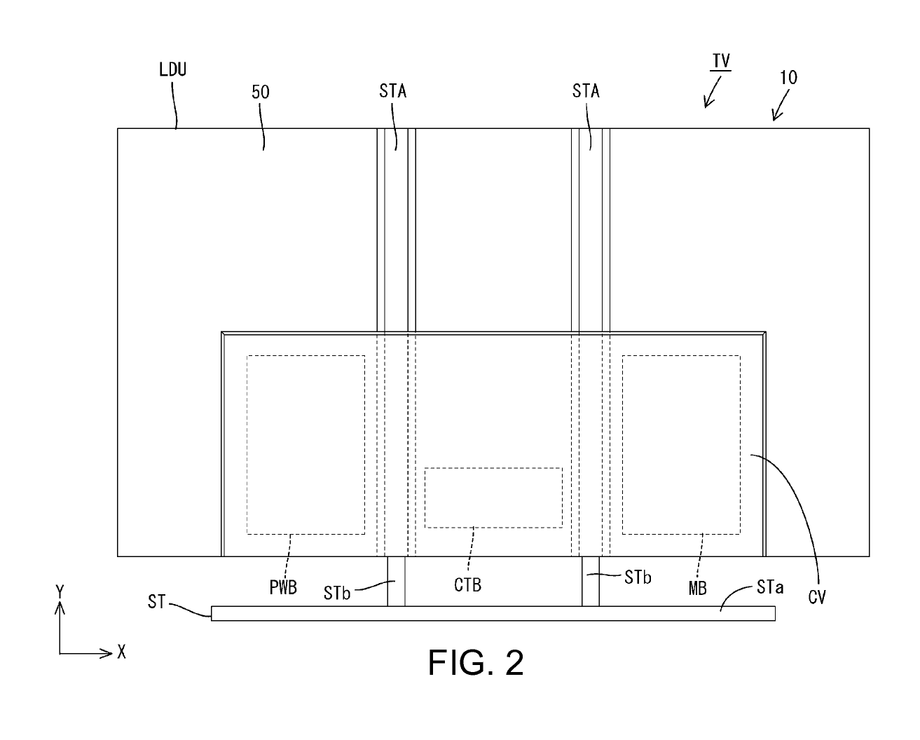

The television receiver TV includes a liquid crystal display unit LDU, boards PWB, MB and CTB installed on the rear surface side (back surface side) of the liquid crystal display unit LDU, a cover member CV installed so as to cover the main boards PWB, MB and CTB on the rear surface of the liquid crystal display unit LDU, and a stand ST. The display surface of the liquid crystal display unit LDU is held in a state of alignment with the vertical direction (Y-axis direction) by the stand ST. The liquid crystal display device 10 according to the present embodiment is what is left after removing at least the configuration for receiving television signals (tuner of main board MB and the like) from the television receiver TV of the above-described configuration. As illustrated in FIG. 2, the liquid crystal display unit LDU has an oblong form (rectangular and extending longitudinally) as a whole, includes a liquid crystal panel 11 that is a display panel, and a backlight device 12 that is an external light source, and is held in an integrated manner by a frame 13 and a housing member 50, which are externally visible members of the liquid crystal display device 10.

First, the configuration of the rear surface side in the liquid crystal display device 10 will be described. As illustrated in FIG. 2, on a rear surface of the liquid crystal display device 10, a pair of stand attachment member STA at positions separated by a space along the X-axis direction are provided, each member extending in the Y-axis direction. The stand attachment members STA have a cross-sectional profile with a substantially channel-like form in which a surface on the liquid crystal display device 10 side is open. A pair of pillar portions STb of the stand ST is inserted into the space maintained between the stand attachment members STA and the liquid crystal display device 10. Note that the spaces in the stand attachment members STA are arranged to allow wiring members (electrical wiring or the like) connected to the LED substrates (example of light source substrate) 18 including the backlight device 12 to pass through. The stand ST is formed from a pedestal portion STa that aligns with the X-axis direction and the Z-axis direction, and a pair of pillar portions STb rising from the pedestal portion STa along the Y-axis direction. A cover member CV is made from a synthetic resin and is attached so as to cover what amounts to approximately a lower half of the rear surface of the liquid crystal display device 10 shown in FIG. 2, while being traversed through the X-axis direction by the pair of stand attachment members STA. Between the cover member CV and the liquid crystal display device 10 is retained a component housing space capable of housing components such as the below-described boards PWB, MB and CTB.

As illustrated in FIG. 2, the boards PWB, MB and CTB include a power supply board PWB, a main board MB, and a control board CTB. The power supply board PWB could also be referred to as a power supply of the liquid crystal display device 10, and supplies driving power to the boards MB and CTB and to the LEDs (example of light source) 17 included on the backlight device 12. Accordingly, the power supply board PWB can be said to also serve as an LED driving substrate for driving LEDs 17. The main board MB includes at least a tuner portion capable of receiving television signals and an image processing portion (which, like the tuner portion, is not shown in the drawings), and is capable of outputting processed image signals to the below-described control board CTB. Note that when the liquid crystal display device 10 is connected to an external image playback device not shown in the drawings, the main board MB is inputted with an image signal from the image playback device, and is capable of processing the image signal using an image processing unit and outputting the processed signal to the control board CTB. The control board CTB functions to convert the image signal input from the main board to a liquid crystal driving signal and supply the converted liquid crystal driving signal to the liquid crystal panel 16.

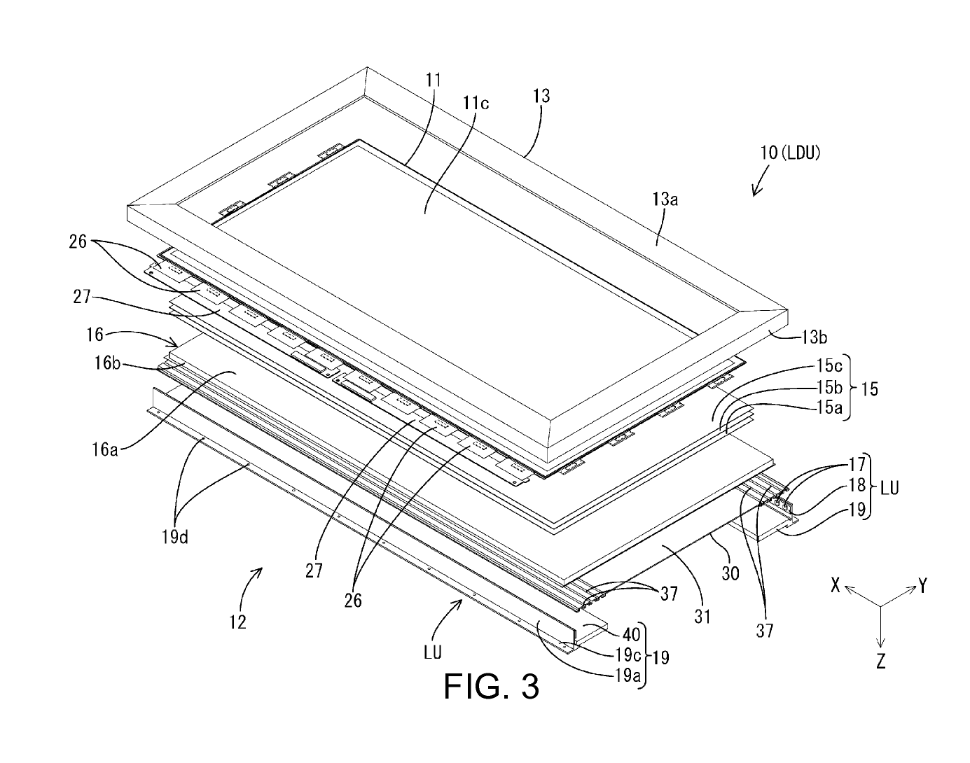

As illustrated in FIG. 3, in the liquid crystal display unit LDU that forms a portion of the liquid crystal display device 10, the main component parts are housed in a space maintained between the frame 13 that creates the external appearance of the display device on the front side and the housing member 50 that creates the external appearance on the rear side. Thus, as the frame 13 provides the front-side external appearance of the liquid crystal display device 10, the frame 13 is a touchable portion of the liquid crystal display device 10. The housing member 50 is formed from a later-described heat dissipating member 19 and a chassis 30. The main components housed within the frame 13 and the housing member 50 include at least a liquid crystal panel 11, an optical member 15 (optical sheet), a light guide plate 16, and the LED unit LU. Of these components, the liquid crystal panel 11, the optical member 15, and the light guide plate 16 are stacked on top of each other, and arranged so as to be held in sandwiched form by the front side frame 13 and the rear side housing member 50. The backlight device 12 is formed from the optical member 15, the light guide plate 16, the LED unit LU, and the chassis 30 (housing member 50), which is a configuration corresponding to the above-described liquid crystal display unit LDU without the liquid crystal panel 11 and frame 13. The LED units LU that form a portion of the backlight device 12 are arranged in a pair such that the light guide plate 16 is sandwiched from both short-side direction (Y-axis direction) sides. The LED unit LU includes LEDs 17 that are the light source, an LED substrate 18 on which the LEDs 17 are mounted, and a heat dissipating member 19 to which the LED substrate 18 is attached. Note that the heat dissipating member 19 of the present embodiment forms a portion of the LED unit LU and a portion of the housing member 50. In the following, components are described.

As illustrated in FIG. 3, the liquid crystal panel 11 has an oblong form (rectangular and extending longitudinally) when seen in plan view, and is constructed in such a way that a pair of glass substrates 11a and 11b with excellent transparency are adhered together in a state of separation across a prescribed gap and liquid crystals are contained in between the two substrates 11a and 11b. Provided on one substrate (array substrate) 11b are switching elements (such as TFTs) connected by mutually perpendicular source wiring and gate wiring, pixel electrodes connected to the switching elements, and alignment film or the like. Provided on the other substrate (CF substrate) 11a are color filters having red (R), green (G) and blue (B) colored portions arranged in a prescribed arrangement, opposite electrode, and alignment film or the like. The liquid crystal panel 11 is mounted by being stacked on the front side of the optical member 15 described below. A surface on the rear side of the liquid crystal panel 11 (outer surface of rear-side polarizing plate) is tightly adhered to the optical member 15 with almost no space therebetween. As a result, intrusions of dust or the like between the liquid crystal panel 11 and the optical member 15 is prevented. A display surface 11c of the liquid crystal panel 11 is made up of a display region provided towards a center of the screen and capable of displaying images, and a non-display region provided towards a peripheral edge of the screen to form a bezel (frame-like area) around the periphery of the display region. The liquid crystal panel 11 is connected to the control board CTB via driver components for driving the liquid crystals and a flexible substrate 26, and is arranged to display images in the display region of the display surface 11c in accordance with signals input from the control board CTB. Note also that polarizing plates (not shown in the drawings) are provided on the outer sides of each of the substrates 11a and 11b.

As illustrated in FIG. 3, the optical member 15, like the liquid crystal panel 11, has an oblong form when seen in plan view, and a size (short-side dimension and long-side dimension) equal to that of the liquid crystal panel 11. The optical member 15 is mounted by being layered on the front side (light-emitting side) of the later-described light guide plate 16 so as to be sandwiched between the above-described liquid crystal panel 11 and the light guide plate 16. The optical member 15 is arranged in three mutually stacked layers, each of which has a sheet-like form. Specifically, stated in order starting at the rear side (light guide plate 16 side), the optical member 15 includes a diffusion sheet 15a, a lens sheet (prism sheet) 15b, and a reflection-type polarizing sheet 15c. Note also that the three sheets 15a, 15b, and 15c are approximately the same size when seen in plan view.

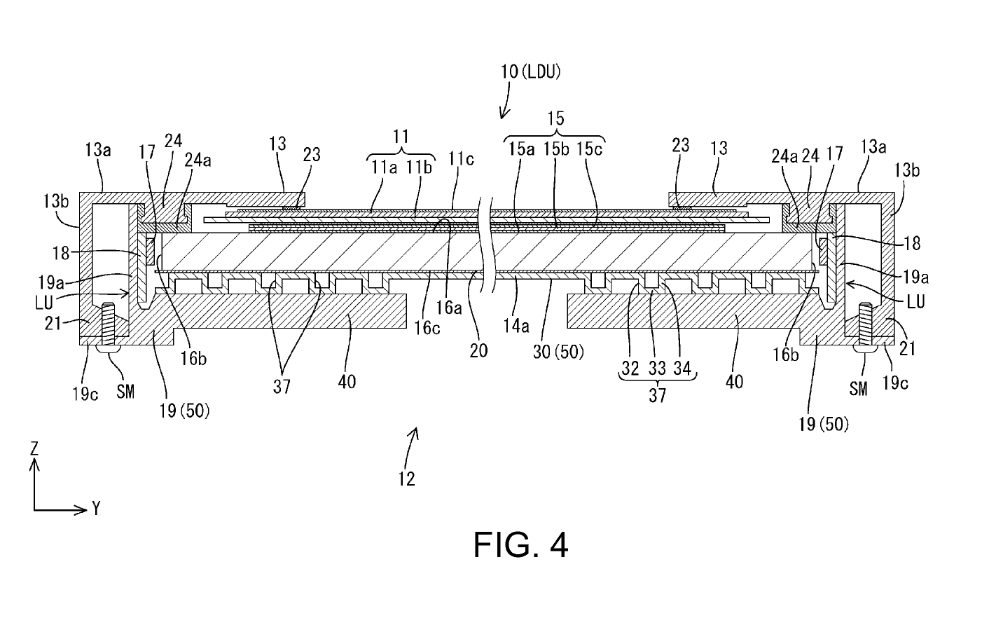

The light guide plate 16 is formed from a synthetic resin material (for example, polycarbonate or an acrylic resin such as PMMA) that has a refractive index sufficiently higher than air and is nearly transparent (has excellent transparency). As illustrated in FIG. 3, the light guide plate 16, in a similar manner to the liquid crystal panel 11 and the optical member 15, has an oblong form when seen in plan view. Further, the light guide plate 16 has a plate-like form and is thicker than the optical member 15. The long-side direction of the main surface is aligned with the X-axis direction, the short-side direction of the same is aligned with the Y-axis direction, and the thickness direction perpendicular to the main surface is aligned with the Z-axis direction. The light guide plate 16 is layered on the rear side of the optical member 15, and arranged to be sandwiched between the optical member 15 and the chassis 30. As illustrated in FIG. 4, the short-side dimension of light guide plate 16 is longer than the short-side dimensions of either the liquid crystal panel 11 or the optical member 15. In the short-side direction, both edges (long-side direction) are arranged to protrude further outward than both edges of both the liquid crystal panel 11 and the optical member 15 (so as not to be overlapped when seen in plan view). The light guide plate 16 is arranged so as to be sandwiched in the Y-axis direction by the pair of LED units LU arranged at the two ends of the short-side direction, and so that light from the LEDs 17 at the two end portions of the short-side direction is guided. Further, the light guide plate 16 has a function for propagating therein light from the LEDs 17 at the two ends of the short-side direction and reorienting the light upwards towards the optical member 15 side (front side).

Of the main surfaces of the light guide plate 16, the surface facing the front side (surface opposing the optical member 15) is a light exiting surface 16a that emits the internal light towards the optical member 15 and the liquid crystal panel 11. Of the peripheral edge surfaces that are adjacent to the main surface of the light guide plate 16, the two long-side edge surfaces that extend longitudinally along the X-axis direction (the two edge surfaces found at the two end portions of the short-side direction) are each arranged so as to directly oppose the respective LEDs 17 (LED substrate 18) across a prescribed gap, thereby forming a pair of light incident faces 16b on which the light generated by the LEDs 17 is incident. The light incident faces 16b are parallel along the X-axis direction and the Z-axis direction (main plate surface of LED substrate 18), and are substantially perpendicular to the light exiting surface 16a. Further, an arrangement direction of the LEDs 17 and the light incident faces 16b matches the Y-axis direction, and is parallel to the light exiting surface 16a.

As illustrated in FIG. 4, on the rear side of the light guide plate 16, which is to say at the surface 16c on the opposite side to the light exiting surface 16a (the surface facing the chassis 30), is provided a reflective sheet 20 capable of reflecting the light emitted to the exterior on the rear side of the surface 16c upwards towards the front side. The reflective sheet 20 is provided covering approximately the entire area of the surface 16c. In other words, the reflective sheet 20 is provided interposed between the chassis 30 and the light guide plate 16. The reflective sheet 20 is made of a synthetic resin, and the surface is white with excellent light-reflecting properties. The reflective sheet 20 has a short-side dimension that is larger than the short-side dimension of the light guide plate 16 and has edge portions that project beyond the light incident faces 16b toward the LEDs 17. As a result of the projecting portions of the reflective sheet 20, light propagating at an angle towards the chassis 30 from the LEDs 17 can be efficiently reflected and oriented towards the light incident faces 16b of the light guide plate 16. Note also that at least one of the light exiting surface 16a and the surface 16c of the light guide plate 16 on the opposite side to the light exiting surface 16a is patterned so as to have a prescribed internal distribution of reflective portions (not shown in the figures) that reflect the internal light and scattering portions that scatter the internal light. Consequently, the light emitted from the light exiting surface 16a is controlled so as to be evenly distributed over the surface.

Next, the LEDs 17 that form a portion of the LED units LU, and the configuration of the LED substrate 18 and the heat dissipating member 19 will be described in the stated order. As illustrated in FIGS. 3 and 4, the LEDs 17 that form a portion of the LED unit LU are constructed by packing LED chips on a substrate portion fixedly attached to the LED substrate 18. For LED chips mounted on the substrate portion, devices having a single main emission wavelength are use used. More specifically, devices that emit only blue light are used. Distributed in the resin material that seals the LED chips is a phosphor that emits light of a prescribed color under excitation by the blue light emitted from the LED chips. As a result, substantially white light is emitted over the entire body of material. Note that the phosphor may be an appropriate combination selected from among, for example, a yellow phosphor that emits yellow light, a green phosphor that emits green light, and a red phosphor that emits red light, or may be a single one of these. The LEDs 17 are of a so-called top surface-emitting type in which a surface on an opposite side to the mounting surface of the LED substrate 18 (in other words, the surface directly opposing the light incident face 16b of the light guide plate 16) forms a main light-emitting surface 17a.

The heat dissipating member 19 that forms a portion of the LED units LU is made of a metal with excellent heat conductivity, such as aluminum or the like. As illustrated in FIGS. 3 and 4, the heat dissipating member 19 includes a light source attachment portion 19a where the LED substrate 18 is attached and a chassis contacting portion 40 that is in contact with the chassis 30, the portions being arranged in a bent form having an approximate L-shape when seen in cross-section. The heat dissipating member 19 further includes a frame attachment portion 19c attached to the frame 13 on the opposite side of the chassis contacting portion 40 to the light source attachment portion 19a. The heat dissipating member 19 has a length dimension that is approximately the same as the length dimension of the above-described chassis 30.

As illustrated in FIGS. 3 and 4, the light source attachment portion 19a has a plate-like form that is parallel to the plate surface of the LED substrate 18 and the light incident face 16b of the light guide plate 16. The long-side direction is aligned with the X-axis direction, the short-side direction is aligned with the Z-axis direction, and the thickness direction is aligned with the Y-axis direction. The LED substrate 18 is attached to an inward-facing plate surface of the light source attachment portion 19a, which is to say the plate surface facing towards the light guide plate 16. The light source attachment portion 19a has a long-side dimension that is approximately equal to the long-side dimension of the LED substrate 18. However, the short-side dimension is larger than the short-side dimension of the LED substrate 18. In addition, both short-side direction end portions of the light source attachment portion 19a project outwards along the Z-axis direction beyond the two end portions of the LED substrate 18. The plate surface on the outer side of the light source attachment portion 19a, which is to say the plate surface on the opposite side to the plate surface where the LED substrate 18 is attached, faces a later-described sidewall portion 13b of the frame 13. In other words, the light source attachment portion 19a is provided interposed between the sidewall portion 13b of the frame 13 and the light guide plate 16. The light source attachment portion 19a rises towards the front side, which is to say towards the frame 13 side, along the Z-axis direction from a below-described chassis contacting portion 40.

As illustrated in FIGS. 3 and 4, the chassis contacting portion 40 has a plate-like form that is parallel to the plate surface of a later-described bottom plate 31 (plate portion of the chassis) and height-difference portion 33 of the chassis 30. The long-side direction of the chassis contacting portion 40 is aligned with the X-axis direction, the short-side direction is aligned with the Y-axis direction, and the thickness direction is aligned with the Z-axis direction. In the chassis contacting portion 40, an end portion on the rear side of the light source attachment portion 19a, which is to say the end portion on the chassis 30 side, protrudes inwards along the Y-axis direction. In contrast to the light source attachment portion 19a that is arranged on the front surface side of the chassis 30, the chassis contacting portion 40 is arranged on the rear side of the chassis 30. The chassis contacting portion 40 is constructed with a long-side dimension that is approximately equal to that of the light source attachment portion 19a, but a short-side dimension and thickness dimension is larger than those of the light source attachment portion 19a, giving the chassis contacting portion 40 good heat dissipating properties. The plate surface on the front side of the chassis contacting portion 40, which is to say the a front surface 40a that faces the chassis 30, is in surface contact with a rear surface of the height-difference portion 33 of the chassis 30.

As illustrated in FIG. 4, the frame attachment portion 19c has a plate-like form that extends along the rear surface of a later-described screw attachment portion 21 of the frame 13. In the same way as the chassis contacting portion 40, the frame attachment portion 19c has a long-side direction that is aligned with the X-axis direction, a short-side direction aligned with the Y-axis direction and a thickness direction aligned with the Z-axis direction. The frame attachment portion 19c is further provided with through holes 19d that are position-matched with screw holes 21a of the screw attachment portion 21 to allow passage of a shaft portion of screw members SM. According to this configuration, the heat dissipating member 19 (housing member 50) can be attached to the frame 13 via the screw members SM. The frame attachment portion 19c is constructed to extend in a height-difference portion-like manner towards the chassis contacting portion 40 and so that an end portion thereof forms a single surface with an outer surface of the sidewall portion 13b. With this configuration, the liquid crystal display device 10 will have a clean and well-designed look.

As illustrated in FIG. 3, the chassis 30 is formed by bending a plate member made of a metal such as iron, and, as whole, has a oblong form for covering substantially the entire light guide plate 16 from the rear side. It is preferable that iron be used as the material for the chassis 30 for reasons of cost and workability. The chassis 30 is provided with a plurality of groove portions 37 at the two end portions of the short-side direction. The configuration of the groove portions 37 is described in detail in a later section. The chassis 30 is combined with the heat dissipating members 19 to form the housing member 50.

As illustrated in FIG. 4, the housing member 50 is constructed by arranging the pair of heat dissipating members 19 so as to oppose each other with the chassis contacting portions 40 pointing inwards, and arranging the two long-side margin areas of the chassis 30 (portions where the groove portions 37 are formed) on the respective front surfaces 40a of the chassis contacting portions 40 of the heat dissipating members 19. The housing member 50 has a C-like shape when viewed in a cross-section in the short-side direction of the chassis 30 (Y-axis direction), and forms a space for housing the main components of the backlight device 12. The housing member 50 is formed from the metal heat dissipating members 19 and chassis 30, and therefore provides a higher mechanical strength (stiffness) than a similar synthetic resin version would offer. Note also that since the heat dissipating members 19 are attached to the frame 13, the combination of the heat dissipating members 19 and the chassis 30 can, for example, be achieved by sandwiching the chassis 30 between the heat dissipating members 19 and the frame 13, or by fixing the later-described height-difference portions 33 to the chassis contacting portions 40 using screw fixtures or another well-known method.

The frame 13 is formed from the metal such as aluminum, and therefore provides both a higher mechanical strength (stiffness) and thermal conductivity than a similar synthetic resin version would offer. As illustrated in FIG. 3, the frame 13 as a whole forms an oblong frame so as to surround the display region of the display surface 11c of the liquid crystal panel 11. The frame 13 has a cross-section that is a substantially “L”-like shape and is formed from a panel holding portion 13a that is parallel with the display surface 11c of the liquid crystal panel 11 and holds the liquid crystal panel 11 from the front side, and a sidewall portion 13b that protrudes towards the rear side from an outer peripheral section of the panel holding portion 13a. Of these portions, the panel holding portion 13a enables formation of a frame-like shape at a peripheral section (non-display region, margin section) of the liquid crystal panel 11, making it possible to hold the peripheral section of the liquid crystal panel 11 around approximately the whole circumference from the front side. The panel holding portion 13a is sufficiently wide to cover, in addition to the peripheral section of the liquid crystal panel 11, the peripheral sections of the optical member 15 and the light guide plate 16, which are disposed outward in a radial direction of the liquid crystal panel 11, and the LED units LU from the front side. The outer surface of the panel holding portion 13a, which faces to the front side, (the surface on the opposite side to the surface opposing the liquid crystal panel 11) is exposed to the exterior at the front side of the liquid crystal display device 10 in the same way as the display surface 11c of the liquid crystal panel 11, and, together with the display surface 11c of the liquid crystal panel 11, forms the front of the liquid crystal display device 10. Moreover, the sidewall portion 13b has a substantially plate-like form that protrudes towards the rear side from the peripheral section (specifically the peripheral edge portion) of the panel holding portion 13a. The sidewall portion 13b makes it possible to surround the entire periphery of the liquid crystal panel 11, optical member 15, light guide plate 16, and LED units LU housed within the device, and to surround almost the entire periphery of the chassis 30 on the rear side. With the sidewall portion 13b, the outer surface around the circumference of the liquid crystal display device 10 is exposed to the exterior around the circumference of the liquid crystal display device 10, and forms a top surface, bottom surface, and both side surfaces of the liquid crystal display device 10.

The frame-like frame 13 having the above-described basic configuration is assembled from four split frame parts formed corresponding to the frame sides (long-side parts and short-side parts). Note that the long-side split frame parts, which cover the LED units LU (see FIG. 4) in addition to the liquid crystal panel 11, the optical member 15, and the light guide plate 16, are formed to be wider than the short-side split frame parts, which do not cover the LED units LU.

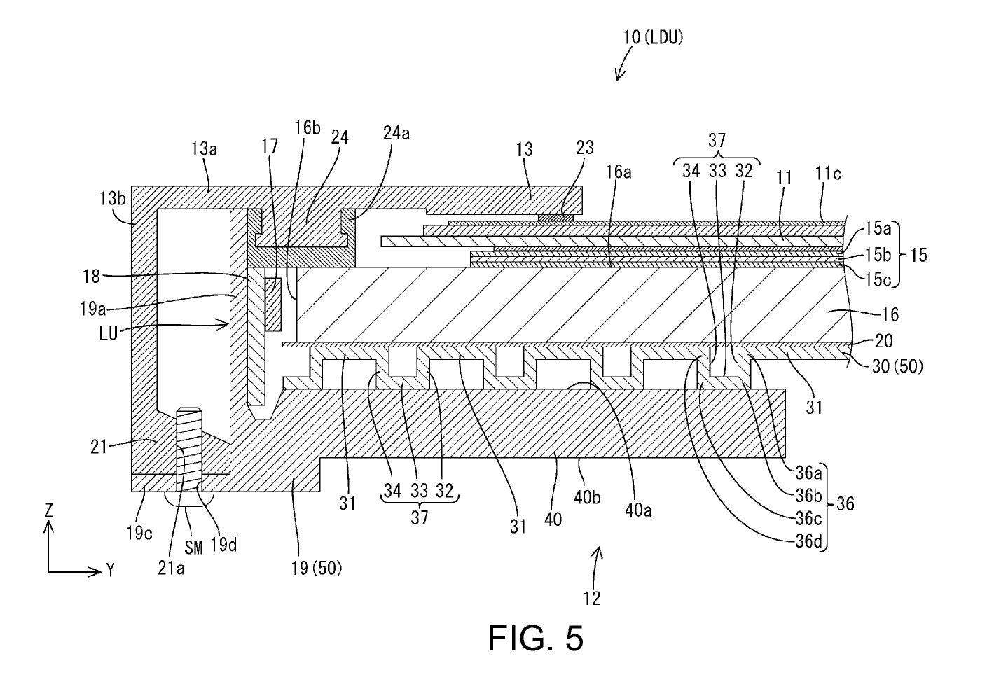

As illustrated in FIGS. 4 and 5, the inner margin section of the panel holding portion 13a is provided with panel cushioning material 23 on the rear side, which is to say the liquid crystal panel 11 side. The panel holding portion 13a is constructed to hold the liquid crystal panel 11 from the front side via the panel cushioning material 23. Further, a holding projection 24 that projects to the rear side is integrally formed at a section of the panel holding portion 13a overlapping the light incident face 16b of the light guide plate 16. The holding projection 24 has a light guide plate cushioning material 24a attached to a distal end surface thereof and holds the light guide plate 16 from the front side via the light guide plate cushioning material 24a. The holding projection 24 and the light guide plate cushioning material 24a are members having light-shielding properties and are capable of suppressing light from the LEDs 17 that is heading directly towards the display panel side. The panel cushioning material 23, the holding projection 24, and the light guide plate cushioning material 24a are formed to extend along the sides in the split frame parts that form the frame 13, and are provided as split parts corresponding to the respective sides. When the split frame parts are assembled, the panel cushioning material 23, the holding projection 24, and light guide plate cushioning material 24a, in the complete state, have frame-like forms that extend around the entire periphery of the panel holding portion 13a.

As illustrated in FIGS. 4 and 5, the sidewall portion 13b has an integrally formed screw attachment portion 21 at a rear side end portion, which is to say at the end portion on the opposite side to the panel holding portion 13a. The screw attachment portion 21 is formed by a portion that projects inwards from an inner side of the sidewall portion 13b, and includes screw holes 21a that open at the rear surface. Note that the screw attachment portion 21 is formed on the long-side sections of the frame 13 that form the frame 13 and not on the short-side sections.

In the following, the configuration of the chassis 30 that forms a main part of the present embodiment will be described in detail. At the two long-side direction edge portions of the backlight device 12 illustrated in FIG. 4, the chassis 30 and the heat dissipating members 19 are symmetrical. Thus, the following explanation includes a description of the configuration of the left-side edge portion (see FIG. 5) while omitting descriptions of the right-side edge portion.

As illustrated in FIG. 5, the chassis 30 includes a bottom plate 31 that extends along the light guide plate 16, a rising portion 32 that rises from the bottom plate 31 on an opposite side to the light guide plate 16 and forms a first corner portion 36a with the bottom plate 31, and a height-difference portion 33 that forms a second corner portion 36b with the rising portion 32 and provides a height-difference portion with respect to the bottom plate 31. The chassis 30 further includes a falling portion 34 that falls from the height-difference portion 33 to the bottom plate 31, forming a third corner portion 36c with the height-difference portion 33 and forming a fourth corner portion 36d with the bottom plate 31. In the following explanation, the first to fourth corner portions 36a, 36b, 36c and 36d are collectively referred to as corner portions 36.

As illustrated in FIG. 5, the dimensions of the rising portion 32 and the falling portion 34 are preferably approximately 2 to 10 times, and more preferably approximately 2 to 5 times the plate thickness of the plate material that forms the chassis 30. With the above configuration, setting the dimensions of the rising portion 32 and falling portion 34 to be at least 2 times the plate thickness of the chassis 30 allows the corner portions 36 to be easily formed. Moreover, it is possible to provide separation of a least 2 times the plate thickness of the chassis 30 between the chassis contacting portion 40 and the bottom plate 31 and between the height-difference portion 33 and light guide plate 16, and to prevent the inner parts of the backlight device 12 reaching high temperatures as a result of heat radiating from the chassis contacting portion 40 and the height-difference portion 33. Further, in the present embodiment, the corner portions 36 formed in the chassis 30 increase the heat resistance of the chassis 30. Thus, provided that the corner portions 36 are formed, an amount of heat conducted from the height-difference portion 33 to the bottom plate 31 will be reduced irrespective of the distance between the chassis contacting portion 40 and the bottom plate 31. Hence, the dimensions of the rising portion 32 and the falling portion 34 can be set to no more than 10 times the plate thickness of the plate material forming the chassis 30 and even more preferably to no more than 5 times the plate thickness, while continuing to reduce the heat conducted from the height-difference portion 33 to the bottom plate 31, thereby contributing to the reduction in the thickness of the backlight device 12.

As illustrated in FIG. 5, the rising portion 32, the height-difference portion 33, and the falling portion 34 are provided by forming in the bottom plate 31 a concave groove portion 37 having an open box-like form when seen in cross-section. The groove portion 37 is, for example, formed by pressing the plate material made of a metal such as iron. The rising portion 32 and the falling portion 34 oppose each other and are interposed by an air layer. The first corner portion 36a and the second corner portion 36b are formed by bending the plate material to a substantial right angle. Similarly, the third corner portion 36c and the fourth corner portion 36d are formed by bending the plate material to a substantial right angle. As illustrated in FIG. 3, the corner portions 36 are provided extending from one edge of the chassis 30 to the other in the long-side direction of the chassis 30. According to the above configuration, the stiffness of the chassis 30 in the long-side direction can be increased by the groove portion 37 and the flatness of the plate surface of the chassis 30 can be increased.

As illustrated in FIG. 3, a plurality of the groove portions 37 are provided (in the present embodiment a total of eight grooves, four at each edge portion). The plurality of groove portions 37 are aligned parallel to the edge portion of the chassis 30. The groove portions 37 are distributed with an equal spacing in positions overlapped by the chassis contacting portions 40 of the heat dissipating members 19. The width dimension between the groove portions 37 is larger than the width dimension of the groove portions 37 (distance separating the rising portion 32 and falling portion 34). In other words, a width dimension of the bottom plate 31 disposed between the groove portions 37 is larger than a width dimension of the height-difference portions 33. In the plurality of groove portions 37, the rising portion 32, the height-difference portion 33, the falling portion 34, and the bottom plate 31 is arranged in a repeating pattern so as to have an undulating profile when seen in cross-section. The height-difference portions 33 are arranged to be coplanar. The bottom plate 31 is arranged to be coplanar and extend parallel to the height-difference portions 33. According to the above configuration, the area of the sections at which the chassis 30 is in contact with the light guide plate 16 and the chassis 30 is in contact with the heat dissipating member 19 is reduced. At the same time, the light guide plate 16, the chassis 30, and the heat dissipating members 19 are parallel and in stable contact.

As illustrated in FIG. 4, sections of the chassis 30 other than the groove portions 37 are denoted as bottom plate 31. In other words, a central portion in the short-side direction of the chassis 30 is denoted as the bottom plate 31. Hence, the rear surface 40b of the chassis contacting portion 40 of the heat dissipating member 19 is provided with an even larger level difference with respect to the bottom plate 31 at the central portion of the chassis 30 than the level difference going from the height-difference portion 33 to the rear surface side. According to this configuration, heating of the region in proximity to the central portion of the chassis 30 by the heat dissipated from the rear surface 40b of the chassis contacting portion 40 can be suppressed to a greater extent than in the case when the rear surface 40b of the chassis contacting portion 40 and the rear surface at the central portion of the chassis 30 are coplanar. Moreover, since the housing member 50 formed from the chassis 30 and the heat dissipating members 19 is constructed with the central portion of the rear surface (bottom plate 31) recessed from the rear surface 40b of the chassis contacting portion 40, other components of the backlight device 12 can be housed in the recessed section.

The present embodiment has the above-described structure. Next, aspects of assembly and the effects of the embodiment will be described. To manufacture the liquid crystal display device 10, separately manufactured components (the frame 13, the chassis 30, the liquid crystal panel 11, the optical member 15, the light guide plate 16, the LED units LU, and the like) are attached to one another. During manufacturing, spaces are formed between the sidewall portion 13b of the frame 13 and the light source attachment portion 19a of the heat dissipating members 19, and a layer of air is interposed therein. At assembly, the components are all attached in an upside down state, which is the state illustrated in FIG. 4 but with the Z-axis direction reversed. First, the frame 13 from the components is set up on a work stand not shown in the drawings with the rear side surface facing vertically upwards.

Next, the liquid crystal panel 11, the optical members 15, and the chassis 30 are layered in the stated order, directly on the rear side surface of the frame 13. Then, the LED units LU, each formed in advance by combining the LEDs 17, the LED substrate 18, and the heat dissipating member 19, are attached to the frame 13. The LED units LU are mounted so that the LEDs 17 face towards the center (inside) of the frame 13 and the chassis contacting portions 40 of the heat dissipating members 19 are seated on the height-difference portions 33 of the chassis 30. Here, spaces corresponding to the heights of the rising portion 32 and falling portion 34 are formed between the chassis contacting portions 40 and the bottom plate 31, and layers of air are interposed between the chassis contacting portions 40 and the bottom plate 31. With frame attachment portion 19c of the heat dissipating member 19 arranged to face the screw attachment portion 21 of the frame 13, through holes 19b1 provided in the frame attachment portion 19c communicate with the screw holes 21a in the screw attachment portion 21. Next, the screw members SM are inserted into the through holes 19d from the rear side and screwed into the screw holes 21a of the screw attachment portion 21. The LED units LU are held in a state of attachment to the screw attachment portions 21 by the screw members SM.

This completes the attachment of the liquid crystal display unit LDU. Thereafter, the stand attachment members STA and the boards PWB, MB and CTB are attached to the rear surface side of the liquid crystal display unit LDU. Then, the liquid crystal display device 10 and the television receiver TV are produced by attaching the stand ST and the cover member CV. In the liquid crystal display device 10 manufactured in the manner described, the liquid crystal panel 11 and the optical members 15 are layered directly on one another. Hence, in comparison to devices having a panel receiving member interposed between the liquid crystal panel 11 and the optical members 15 to prevent contact, the number of parts and the amount of assembly is reduced. Thus, in addition to promoting thinner and lighter liquid crystal display devices, the liquid crystal display device 10 also serves to reduce production costs.

When the liquid crystal display device 10 manufactured in the manner described is powered ON, the liquid crystal panel 11 is supplied with power from the power supply board PWB, and with signals from the control board CTB via the substrate 27 and the flexible substrate 26 (drivers), and the driving of the LEDs 17 that make up the backlight device 12 is controlled accordingly. The light from the LEDs 17 is guided by the light guide plate 16 to pass through the optical member 15, and is thereby converted to uniform planar light. Thus, the liquid crystal panel 11 is illuminated by uniform planar light and prescribed images are displayed on the liquid crystal panel 11. The following describes the effects of the backlight device 12 in more detail. As illustrated in FIG. 4, when the LEDs 17 are lit, the light emitted from the LEDs 17 is incident on the light incident faces 16b of the light guide plate 16. The light incident on the light incident faces 16b is totally reflected by the boundary surfaces with the external air layer of the light guide plate 16 or by the reflective sheet 20, and is thereby propagated within the light guide plate 16. In this process, the light is reflected or scattered by reflective portions or scattering portions not shown in the drawings and emitted from the light exiting surface 16a, thereby illuminating the optical member 15.

However, as the liquid crystal display device 10 is used, the LEDs 17 illuminate and generate heat. The heat generated by the LEDs 17 is initially transmitted to the light source attachment portions 19a of the heat dissipating members 19 via the LED substrates 18. The heat is then conducted from the light source attachment portions 19a to the chassis contacting portions 40 and efficiently dissipated by the air layers on rearward side of the rear surfaces 40b of the chassis contacting portions 40. Thus, the above-described configuration promotes heat dissipation from the backlight device 12. In addition, since each chassis contacting portion 40 has the front surface 40a that is in contact with the height-difference portions 33 of the chassis 30, a portion of the heat is transmitted from the chassis contacting portion 40 to the height-difference portions 33.

In the backlight device 12 according to the present embodiment, the chassis 30 is made of metal and the first corner portions 36a and second corner portions 36b are present between the height-difference portions 33 and the bottom plate 31 on the rising portion 32 side. Hence, the conduction of heat from the height-difference portion 33 side to the bottom plate 31 side is more difficult than when the height-difference portions 33 and bottom plate 31 form a continuing flat plane. Similarly, the third corner portions 36c and the fourth corner portions 36d are present on the falling portion 34 side, inhibiting the conduction of heat from the height-difference portion 33 side to the bottom plate 31 side. Consequently, in comparison to the case in which the height-difference portions 33 and the bottom plate 31 form a continuing flat surface, the amount of heat transmitted from the chassis contacting portions 40 of the heat dissipating members 19 to the bottom plate 31 is reduced, and the amount of heat dissipated from the chassis contacting portions 40 to the rear surface side is increased. According to this configuration, the backlight device 12 can appropriately dissipate internal heat to the rear surface side.

As described above, the backlight device 12 includes an LED 17; a light guide plate 16 that opposes the LEDs 17 and includes a light incident face 16b where light from the LEDs 17 is incident and a light exiting surface 16a that emits the incident light; an optical member 15 arranged on the light exiting surface 16a side of the light guide plate 16; a chassis 30 formed by bending a metal plate material and arranged on an opposite side of the light guide plate 16 to the light exiting surface 16a, the chassis 30 including a bottom plate 31 that extends along the light guide plate 16, a rising portion 32 that rises from the bottom plate 31 on an opposite side to the light guide plate 16 and forms a first corner portion 36a with the bottom plate 31, and a height-difference portion 33 that forms a second corner portion 36b with the rising portion 32 and provides a height-difference portion with respect to the bottom plate 31; and a heat dissipating member 19 that dissipates heat of the LEDs 17, the heat dissipating member 19 including a light source attachment portion 19a to which the LEDs 17 are attached and a chassis contacting portion 40 that is contiguous with the light source attachment portion 19a and is in contact with the height-difference portion 33 from the opposite side to the light guide plate 16.

In the above-described backlight device 12, the first corner portion 36a and the second corner portion 36b are formed between the bottom plate 31 and the height-difference portion 33 in the chassis 30 by bending the metal material. In this process, since warping and cracking occur when bending a metal, corner portions formed by bending the metal material have a higher thermal resistance than flat portions. Hence, in the above-described backlight device 12, the conduction of heat from the height-difference portion 33 to the bottom plate 31 is more difficult than when the height-difference portion 33 and the bottom plate 31 form a continuous flat plane.

Also, since the chassis contacting portion 40 of the heat dissipating member 19 is in contact with the height-difference portion 33 from the opposite side to the light guide plate 16, heat is dissipated via the chassis contacting portion 40. In comparison to the case in which the height-difference portion 33 and the bottom plate 31 form a continuous flat surface, the amount of heat dissipated from the chassis contacting portion 40 on the chassis 30 side is reduced, and the amount of heat dissipated from the opposite side to the chassis 30 (the rear surface 40b side) is increased. As a result, it becomes more difficult for the heat from the heat dissipating member 19 to reach the optical member 15, which is disposed on the chassis 30 side with respect to the chassis contacting portion 40. Hence, the generation of wrinkling in the optical member 15 due to thermal expansion of the section of the optical member 15 overlapping the chassis contacting portion 40 can be suppressed.

Specifically, in the present embodiment, as illustrated in FIG. 5, the edge of the optical member 15 on the LEDs 17 side overlaps approximately ⅔ of the chassis contacting portion 40. Here, if the chassis contacting portion 40 were to be arranged on the front side of the chassis 30 (light guide plate 16 side), heat from the chassis contacting portion 40 would be transmitted to the optical member 15 via the reflective sheet 20 and the light guide plate 16. Moreover, if the chassis contacting portion 40 were arranged on the rear side of the chassis 30 (opposite side to the light guide plate 16) but the configuration did not include the rising portion 32 and the height-difference portion 33, heat from the chassis contacting portion 40 would be easily transmitted from the chassis contacting portion 40 to the chassis 30, and then via the chassis 30, the reflective sheet 20, and the light guide plate 16 to the optical member 15. However, in the present embodiment, the chassis contacting portion 40 is provided on the rear side of the chassis 30 (opposite side to the light guide plate 16), and the chassis 30 includes both the rising portion 32 and the height-difference portion 33. Thus, the thermal resistance of the first corner portion 36a and the second corner portion 36b is high, and heat is not easily conducted from the height-difference portion 33 to the bottom plate 31. Hence, with an extremely simple configuration in which the rising portion 32 and the height-difference portion 33 are formed by bending the chassis 30, it is made more difficult for heat to be transferred to the edge of the optical member 15.

Further, in the backlight device 12 of the present embodiment, the chassis 30 further includes a falling portion 34 that falls from the height-difference portion 33 to the bottom plate 31, forming a third corner portion 36c with the height-difference portion 33 and forming a fourth corner portion 36d with the bottom plate 31. The rising portion 32, the height-difference portion 33, and the falling portion 34 are provided by forming a concave groove portion 37 in the bottom plate 31. With the above configuration, the height-difference portion 33 can be supported with respect to the bottom plate 31 by the rising portion 32 and the falling portion 34, and the strength of the height-difference portion 33 can be set to be high. Further, since the third corner portion 36c and the fourth corner portion 36d are formed between the height-difference portion 33 and the bottom plate 31 by bending the metal material, heat is not easily conducted from the height-difference portion 33 to the bottom plate 31 via the falling portion 34.

In the backlight device 12 of the present embodiment, a plurality of the groove portions 37 are provided and the plurality of groove portions 37 are aligned parallel to the edge of the chassis 30. According the above configuration, an area of plate surface of the height-difference portions 33 is smaller than in the case that the height-difference portion 33 is formed by a single groove portion 37, with the height-difference portions 33 being in contact with the chassis contacting portion 40 over a wide area with gaps therebetween. Hence, the chassis 30 can be stably in contact with the heat dissipating members 19 with reduced heat being transferred from the chassis contacting portion 40 to the height-difference portions 33.

In the backlight device 12 of the present embodiment, the rising portion 32 and the falling portion 34 are interposed by an air layer. According to the above configuration, the height-difference portions 33 and the light guide plate 16 are interposed by a layer of air and can therefore be thermally insulated from each other.

Further, in the backlight device 12 of the present embodiment, the first corner portion 36a and the second corner portion 36b are formed by bending the plate material to a substantial right angle. According to the above configuration, a higher level of the thermal insulation can be achieved between the first corner portion 36a and the second corner portion 36b and the conduction of heat from the height-difference portion 33 to the bottom plate 31 can, advantageously, be made even more difficult, than in the case that the material is bent to an obtuse angle.

In the backlight device 12 of the present embodiment, the chassis 30 can be made of metal. According the above configuration, it is generally possible to contribute to reducing manufacturing costs through the use of a cheaper metal while still suppressing wrinkling, deflection and the like in the optical member 15. Such effects are possible even when the chassis 30 made of a metal with lower thermal conductivity than aluminum or the like is used.

The liquid crystal display device 10 (display device) of the present embodiment includes the above-described backlight device 12 and the liquid crystal panel 11 (display panel) that performs display using the light from the backlight device 12.

According to the above liquid crystal display device 10, the backlight device 12 that supplies light to the liquid crystal panel 11 suppresses deformation such as wrinkling and deflection of the optical member 15. Hence, it is possible to realize a display having excellent display quality.

The liquid crystal display device 10 of the present embodiment further includes the frame 13 arranged on the display surface side of the liquid crystal panel 11 and housing, in a sandwich with the heat dissipating members 19, the liquid crystal panel 11, the LEDs 17, the light guide plate 16, and the chassis 30. The heat dissipating members 19 include the frame attachment portion 19c attached to the frame 13 on the side of the chassis contacting portion 40 opposite to the light source attachment portion 19a. According to the above configuration, heat from the light source attachment portion 19a is dissipated by the chassis contacting portion 40. Hence, heat is less easily conducted to the frame attachment portion 19c side, and the transmission of the heat from the heat dissipating member 19 from the frame attachment portion 19c to the frame 13 can be suppressed.

In the liquid crystal display device 10 of the present embodiment, the frame 13 has an L-shape when viewed in cross-section, and includes a panel holding portion 13a that holds the liquid crystal panel 11 from the display surface 11c side, and a sidewall portion 13b that protrudes from an outer side section of the panel holding portion 13a towards an opposite side to the display surface side. The light source attachment portion 19a faces the sidewall portion 13b and an air layer is interposed between the light source attachment portion 19a and the sidewall portion 13b. According to the above configuration, the light source attachment portion 19a and the sidewall portion 13b can be thermally insulated from each other, and the transmission of the heat from the heat dissipating member 19 from the light source attachment portion 19a to the frame can be suppressed even further.

In the present embodiment, the liquid crystal panel 11 is provided as an example of a display panel. Display devices such as the as the liquid crystal display device 10 can be applied in various applications, including televisions and PC displays, and are especially suitable for large screen applications.

### Embodiment 2

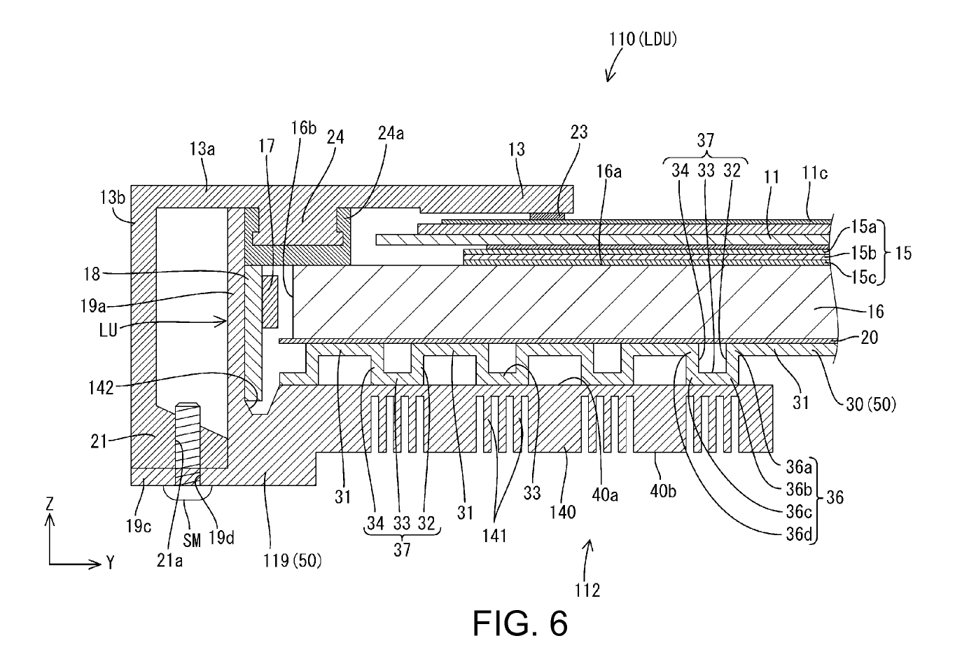

Embodiment 2 of the present invention is described below based on FIG. 6. Embodiment 2 differs from Embodiment 1 in that heat dissipating fins 141 are provided on the chassis contacting portion 140 of the heat dissipating members 119. Repetitious descriptions of structures, operations and effects similar to the above described Embodiment 1 will be omitted.

The chassis contacting portion 140 is provided with heat dissipating fins 141 on a surface on the opposite side to the chassis 30 (rear surface 40b) at a section that overlaps the height-difference portions 33. The heat dissipating fins 141 are integrally provided with the chassis contacting portion 140 and are formed by cutting a plurality of parallel grooves in the plate-like chassis contacting portion 140. Specifically, the chassis contacting portion 140 is constructed so that a thickness dimension at portions where the heat dissipating fins 141 are not provided is the same as the protruding dimension of the heat dissipating fins 141. According to the above configuration, portions where the heat dissipating fins 141 are not provided secure the cross-sectional area of the chassis contacting portion 140, improving the ease with which heat is conducted from sections near the light source attachment portion 19a to sections far away from the same.

The heat dissipating fins 141 are formed by a plurality of ribs that extend along corner portions 142 formed between the light source attachment portion 19a and the chassis contacting portion 140. In the present embodiment, three ribs are provided in correspondence to each height-difference portion 33. According to the above configuration, the surface area of the chassis contacting portion 140 can be increased, thereby promoting heat dissipation from the chassis contacting portion 140.

In a backlight device 112 of the present embodiment, the chassis contacting portion 140 is provided with the heat dissipating fins 141 on the surfaces on the opposite side to the chassis 30 at sections overlapping with the height-difference portions 33. According to the above configuration, heat dissipation efficiency can be improved on the side of the chassis contacting portion 140 opposite to the chassis 30 (rear surface 40b side) at sections overlapping the height-difference portions 33. Hence, transmission of heat from the chassis contacting portion 140 to the chassis 30 can, advantageously, be further reduced.

Moreover, in the backlight device 112 of the present embodiment, the heat dissipating member 119 is formed so that the light source attachment portion 19a and the chassis contacting portion 140 form an L-shape when seen in cross-section. The heat dissipating fins 141 are formed by the plurality of ribs that extend along the corner portions 142 formed between the light source attachment portion 19a and the chassis contacting portion 140. According to the above configuration, the heat dissipating fins 141 can be formed simultaneously with the chassis contacting portion 140 and the light source attachment portion 19a when extruding the heat dissipating member 119.

### Embodiment 3

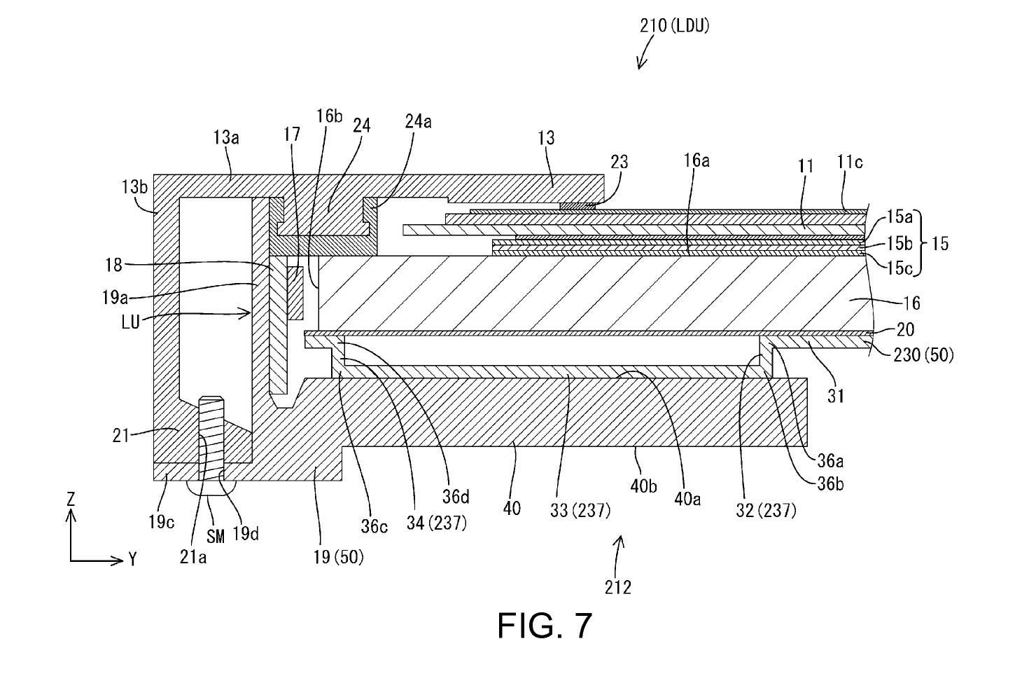

Embodiment 3 of the present invention is described below based on FIG. 7. Embodiment 3 differs from Embodiment 1 in that a single groove portion 237 is provided at edge portions of a chassis 230. Repetitious descriptions of structures, operations and effects similar to the above described Embodiment 1 will be omitted.

A single groove portion 237 is provided at each first and second end portions of the short-side direction of the chassis 230, such that two groove portions 237 are provided in the chassis 230 as a whole. The groove portions 237 are arranged along edge portions of the chassis 230. The groove portions 237 are arranged in positions overlapping the chassis contacting portions 40 of the heat dissipating members 19, and a width dimension of the height-difference portion 33 is set to be slightly smaller that the width dimension of the chassis contacting portion 40. According to the above configuration, the rising portion 32, the height-difference portion 33, and the falling portion 34 can be provided while reducing the number of bends in the chassis 230.

### Other Embodiments

The present invention is not limited the embodiments explained in the above descriptions and drawings. For example, the following embodiments are also included in the technological scope of the present invention.

(1) In the above-described embodiments, examples in which the chassis includes groove portions were described. However, configurations in which the chassis does not have a falling portion, but rather has a height-difference portion form including the bottom plate, the rising portion, and the height-difference portion are also included in the present invention.

(2) In the above-described embodiments, examples in which the first corner portion and second corner portion and the third corner portion and fourth corner portion were formed by bending a plate member to substantial right-angles were described. However, the bending angle at the corner portions is not limited to being a right angle.

(3) In the above-described embodiments, examples in which the height-difference portions were provided along both long-side direction edge portions of the chassis were described. However, it is sufficient that the height-difference portions are arranged in proximity to the LED units, and the arrangement and configuration of the height-difference portion in the chassis is not otherwise limited.

(4) In the above-described embodiments, examples in which two corner portions were provided between the bottom plate and the height-difference portion were described. However, a plurality of height-difference portions formed using three or more corner portions may be provided between the bottom plate and the height-difference portion.

(5) In addition to the above-described embodiments, appropriate modifications can also be made to the material, form, configuration of the chassis, to the arrangement or form of the height-difference portion or groove portions, or the like.

(6) In addition to the above-described embodiments, appropriate modifications can also be made to the form and configuration of the heat dissipating members. For example, a configuration may be used in which a member of lower thermal conductivity than the heat dissipating members, made of polycarbonate or the like, is provided on the chassis-side surface of the chassis contacting portion.

(7) In the above-described embodiments, examples were described in which the heat dissipating members were exposed at the rear surface, but the heat dissipating members may instead be covered by a cover member or the like. Alternatively, to promote heat dissipation form the rear surface of the heat dissipating members, a configuration including fins or the like on the rear surface of the heat dissipating member to generate air currents may be used.

(8) In the above-described embodiments, examples of a liquid crystal display device using the liquid crystal panel as a display panel were described, but the present invention can also be applied to a display device using other types of display panel.

(9) In above-described embodiments, examples were described in which the LED units (LED substrates) were arranged to face each other at respective long-side edge portions of the light guide plate. However, configurations in which the LED units are arranged to face each other at respective short-side edge portions of the light guide plate are also included in the present invention.

(10) Besides the example of (9), arrangements in which opposing LED unit (LED substrate) pairs were arranged at both long-side edge portions and short-side end portions of the light guide plate so as to provide a total of four LED units, and in which a single LED unit is provided at one of the long-side edge portions or one of the short-side end portions are also included in the present invention. Moreover, arrangements in which LED units are provided in opposition at any three sides of the light guide plate are also included in the present invention.

(11) In above-described embodiments, an arrangement was described in which a single LED unit (LED substrate) was disposed on a given side of the light guide plate. However, arrangements in which two or more LED units are provided on a given side of the light guide plate may also be used.

(12) In above-described embodiments, an arrangement was described in which LEDs were used as the light source, but a different light source such as organic EL is also possible.

The above has described embodiments of the present invention in detail, but these are to be construed as mere examples and do not limit the scope of the patent claims. The technologies of the patent claims include arrangements resulting from various modifications and changes to the examples described in the above examples.

### DESCRIPTION OF REFERENCE CHARACTERS

TV television receiver
LDU liquid crystal display unit
PWB power board
MB main board
CTB control board
CV cover member
ST stand
LU LED unit
10, 110, 210 liquid crystal display device (display device)
11 liquid crystal panel (display panel)
12, 112, 212 backlight device (illumination device)
13 frame
13a panel holding portion
13b sidewall portion
15 optical member (optical sheet)
16 light guide plate
16a light exiting surface
16b light incident face
17 LED
18 LED substrate
19 heat dissipating member
19a light source attachment portion
19c frame attachment portion
20 reflective sheet
30, 230 chassis
31 bottom plate
32 rising portion
33 height-difference portion
34 falling portion
36 corner portion
36a first corner portion
36b second corner portion
36c third corner portion
36d fourth corner portion
37, 237 groove portion
40, 140 chassis contacting portion
141 heat dissipating fin
142 corner portion

1. An illumination device, comprising:
a light source;
a light guide plate that faces said light source and that has a light incident face on which light from said light source is incident and a light exiting surface from which light exits;
an optical sheet arranged on a side of said light guide plate adjacent to the light exiting surface thereof;
a chassis formed by bending a metal plate and arranged on a side of said light guide plate opposite to the light exiting surface thereof, said chassis being constituted of a plate portion that extends along said light guide plate, a first extending portion that continues from the plate portion and extends in a direction opposite to the light guide plate and that forms a first corner portion with said plate portion, and a height-difference portion that forms a second corner portion with said first extending portion and provides a difference in height with respect to the plate portion; and
a heat dissipating member that dissipates heat from the light source, said heat dissipating member being constituted of a light source attachment portion to which said light source is attached and a chassis contacting portion that is contiguous with said light source attachment portion and in contact with said height-difference portion from a side opposite to the light guide plate.

2. The illumination device according to claim 1,
wherein said chassis further includes a second extending portion that continues from said height-difference portion and extends towards said plate portion in a direction opposite to the heat dissipating member, said second extending portion forming a third corner portion with said height-difference portion and forming a fourth corner portion with said plate portion, and
wherein said first extending portion, said height-difference portion, and said second extending portion are provided by forming a recessed groove in said chassis.

3. The illumination device according to claim 2,
wherein a plurality of said recessed grooves are provided, and
wherein said plurality of recessed grooves are arranged so as to be aligned along an edge of the chassis.

4. The illumination device according to claim 2, wherein an air layer is defined between said first extending portion and said second extending portion.

5. The illumination device according to claim 1, wherein said first corner portion and said second corner portion are formed by bending said plate to a substantial right angle.

6. The illumination device according to claim 1, wherein said chassis is made of metal.

7. The illumination device according to claim 1, wherein said chassis contacting portion of the heat dissipating member is provided with a heat dissipating fin on a surface thereof opposite to the chassis at a section that overlaps the height-difference portion.

8. The illumination device according to claim 7,
wherein the heat dissipating member is configured such that said light source attachment portion and said chassis contacting portion thereof form an upside down L-shape in a cross-sectional view, and
wherein said heat dissipating fin is constituted of a plurality of ribs that extend along the height-difference portion of the chassis in a cross-sectional view.

9. The illumination device according to claim 1, wherein an air layer is defined between said chassis contacting portion of the heat dissipating member and said plate portion of the chassis.

10. A display device comprising:
the illumination device according to claim 1; and
a display panel that performs display using light from said illumination device.

11. The display device according to claim 10, further comprising:
a frame arranged on a display surface side of said display panel, said frame and said heat dissipating member sandwiching and housing the display panel, the light source, the light guide plate, and the chassis therebetween,
wherein said heat dissipating member further includes a frame attachment portion attached to said frame and arranged so as to be on an outer side of said light source attachment portion on a side opposite to said chassis contacting portion on an inner side of said light source attachment portion opposite to the light source.

12. The display device according claim 11,
wherein said frame has an upside-down L-shape in a cross-sectional view and includes a panel holding portion that holds said display panel from said display surface side and a sidewall that protrudes from an outer side of the panel holding portion towards a side opposite to said display surface side, and
wherein said light source attachment portion faces said sidewall and an air layer is defined between said light source attachment portion and said sidewall.

13. The display device according to claim 11, wherein said frame attachment portion has a height-difference portion-like shape that protrudes further towards a side opposite to said chassis than said chassis contacting portion.

14. The display device according to claim 10, wherein said display panel is a liquid crystal panel using liquid crystal.

15. A television receiver, comprising the display device according to claim 10.
